(19) United States
(12) Patent Application Publication
(10) Pub. No.: US 2002/0124177 A1
(43) Pub. Date: Sep. 5, 2002

(54) Methods for encrypting and decrypting electronically stored medical records and other digital documents for secure storage, retrieval and sharing of such documents

(76) Inventors: Travis Kelly Harper, Sandy, UT (US); Benjamin Clark Stout, South Jordan, UT (US)

Correspondence Address: John M. Guynn, WORKMAN, NYDEGGER & SEELEY, 1000 Eagle Gate Tower, 60 East South Temple, Salt Lake City, UT, 84111, US

(21) Appl. No.: 09/764,020

(22) Filed: Jan. 17, 2001

(51) Int. Cl. H04L 9/32

(52) U.S. Cl. 713/189

(57) ABSTRACT

Methods and systems for encrypting and decrypting electronic files and then limiting the ability to copy, alter or send the decrypted information so as to preserve the integrity of the file. The encryption and decryption systems involve an essentially symmetric cipher or key system in which the same key is used to both encrypt the original plaintext and decrypt the resulting ciphertext. The key, or cipher, includes public and private components. The “public key” is typically stored and sent together with the encrypted file in the form of a unique file type that includes the public key appended to the front encrypted file portion. A new public key is typically generated for each electronic file that is encrypted. The “private key” is known only to the encrypting and decrypting parties and may be used to encrypt and decrypt multiple files, or it may be uniquely generated for each encrypted file. It may be hard-coded within the decryption software provided to the decrypting party, or it may be obtained by means of a secure password-protected login procedure. The software utilized in decrypting the encrypted file may also provide limited output, such as merely the ability to view and/or print a hard copy of the decrypted file.

### BACKGROUND OF THE INVENTION

1. The Field of the Invention

The present invention is in the field of encryption and decryption of electronic documents, such as image or text documents in digital form, so as to provide enhanced security during storage, retrieval, sharing, and viewing of such documents. More particularly, the invention is in the field of encryption, decryption, and display of electronic records, such as digitized medical records that include sensitive information, so as to limit access to, and the ability to alter, such records, thereby preserving sensitive information contained therein.

2. Background and Related Art

Medical records are typically created, stored, transferred and copied in tangible form, typically as paper documents. Doctors most often create medical records by hand writing information onto pre-printed forms, which are manually placed within patient files. Such records may include times and dates of diagnosis and treatment of a patient, the condition being attended to, the symptoms that led to the diagnosis, and the specific procedures, medicine or other care used in treatment of the condition. The records may also include other personal and confidential information, some or all of which may be protected by the patient-doctor privilege.

The patient-doctor privilege exists, among other things, to encourage full disclosure of medical conditions and other matters of a potentially personal nature, both past and present, between doctor and patient. Full disclosure facilitates diagnosis and treatment. Confidence that information disclosed will be kept confidential promotes open and honest communication and disclosure between doctor and patient. Conversely, fear that confidential and sensitive information between a doctor and patient might be disclosed to others may inhibit full disclosure, thus compromising the ability of a doctor to adequately treat a patient. To allay such fears, the law strictly regulates who can access sensitive patient records.

In view of the patient-doctor privilege, and pursuant to standard professional custom, hospitals, clinics, doctor's offices and other facilities that store confidential medical records usually have procedures and safeguards for maintaining the confidentiality of records. Where such records are kept in tangible form, restricting access through security clearance measures is straightforward. When copies of records are created, controlling access becomes more difficult. Where records are copied in tangible form, it is a matter of limiting and controlling access to the tangible copy, typically through strict contractual provisions as well as the aforementioned legal restrictions on who rightfully has access to a confidential medical record. Where the medical record is copied into digital form, special measures must be followed to prevent unauthorized access, copying, and distribution. Moreover, because digital documents are generally more easily altered or obliterated, safeguards must ensure the integrity of the medical record from unauthorized alteration or obliteration.

Examples of security systems for limiting access to sensitive medical records and/or preventing unauthorized alteration thereof are set forth in U.S. Pat. No. 5,619,571 to Sandstrom et al., U.S. Pat. No. 5,784,461 to Shaffer et al., U.S. Pat. No. 5,579,393 to Conner et al., and U.S. Pat. No. 5,809,145 to Slik et al. The foregoing patents mainly disclose encrypted passwords and fragments of the document in question to prevent access to the actual document. They do not generally involve encrypting an entire file and then making the encrypted file publicly available, though unintelligible, such as when an electronic document is sent in encrypted form through the Internet. Whereas the foregoing patents may provide adequate security vis-à-vis closed computer systems or networks where access is generally limited, they may not adequately protect the confidentiality and integrity of digital documents that are publicly accessible or shared in a manner that does not prevent unauthorized third parties from capturing such digital documents.

A common encryption method used currently with regard to Internet transactions is the Rivest-Shamir-Aldeman (RSA) encryption algorithm (U.S. Pat. No. 4,405,829 to Rivest et al.), which relies on a public key (or asymmetric) protocol. RSA encryption uses extremely large prime numbers that require an exponential amount of time to decipher, where the exponent is determined by the size of the number of bits that make up the prime number. In RSA encryption, the public key may be used by anyone to encrypt an original electronic document (“plaintext” or “cleartext”) but cannot be used to decrypt (or decipher) the encrypted document (“ciphertext”). Only someone having access to the private key can decrypt or decipher the encrypted file.

RSA encryption is therefore well suited for systems in which a large number of parties (e.g., clients) wish to send encrypted data to one central party (e.g., a financial institution). The public key can be made generally available to the public at large, such as through web browser implemented encryption when the client logs into the central party's web site. This allows every client to encrypt sensitive information before sending it to the central party using the same public key. Because only the central party has possession or access to the private key, only the central party can decrypt the encrypted data that is sent to it over the Internet. Presently, 128-bit RSA encryption is the standard protocol for sending sensitive information from a client to a centralized institution such as a bank, online broker, or other financial institution. This Internet protocol is commonly referred to as HyperText Transfer Protocol Secure (HTTPS), and the encryption is commonly referred to as Secure Socket Layer (SSL).

Nevertheless, because it is necessary to restrict access to the private key to prevent unauthorized capture and access of encrypted data, asymmetric encryption methods such as RSA encryption may not be best suited in the case where a central party wishes to send one or more encrypted files to a number of different receiving parties who will need to decrypt the encrypted files. In such cases, the private key will have to be made available to all such receiving parties. As is plainly seen, making the private key generally available to a number of different parties obviously reduces the ability of the central party to keep the private key secret, thus comprising the privacy of the information being sent to the different parties over the Internet or other nonsecure channel.

Another problem with conventional encryption and decryption methods and systems, whether symmetric or asymmetric encryption, is that once the receiving party has been given the ability to decrypt the encrypted message so as to recover the original plaintext file, there is nothing to prevent that party from saving, altering, or sending the decrypted plaintext file to an unauthorized party.

In view of the foregoing, it would be an improvement in the art to provide encryption and decryption methods and systems that were specifically tailored for use by a central party who wishes to securely send encrypted files to a number of different receiving parties while maintaining control over the key(s) necessary to decrypt the encrypted files.

In particular, improved encryption and decryption methods and systems are needed that could adequately prevent unauthorized access to medical records or other confidential electronic documents transmitted over nonsecure communications channels, such as the Internet, by a central party to a number of different receiving parties.

It would be an additional improvement in the art to provide improved encryption and decryption methods and systems that were integrated with a display system that allowed the receiving party to view the decrypted plaintext document but which could, if desired, be configured to prevent the viewing party from saving, altering or sending the decrypted plaintext file to an unauthorized party.

Such methods and systems for encrypting, decrypting and displaying sensitive medical records and other electronic documents or files are disclosed and claimed herein.

### SUMMARY OF THE INVENTION

The present invention relates to methods and systems for encrypting and decrypting electronic graphic or other files. The encryption and decryption algorithms may advantageously be integrated within specialized viewing software that could be configured, if desired, to prevent the viewing party from saving, altering or sending the decrypted plaintext file to an unauthorized party. The inventive methods and systems are particularly suitable when third-party access to the actual electronic file cannot be prevented, such as when an encrypted file is transmitted over the Internet or other public or quasi-public communications channel.

The methods and systems of the invention for securely encrypting and then decrypting files are suitable for use with graphic files, such as an electronic document that is a “Tagged Image Format File” (TIFF or .tif). Of course, the inventive methods and systems could be used to encrypt and decrypt other types of files, such as text files or JPEG, BMP, GIF files, and the like. An example of a present use for the inventive encryption methods and systems is where a custodian of sensitive and confidential medical records wishes to share such records over a nonsecure communications channel, such as the Internet, with a number of authorized third parties, such as life insurers, property and casualty insurers, and personal-injury and defense attorneys. Of course, the inventive encryption methods and systems may be used to protect the security of virtually any sensitive or confidential electronic document, whether in graphic or text form.

The inventive encryption methods and systems utilize an essentially symmetric encryption and decryption algorithm in which a single set of keys is used in both the encryption and decryption processes. A point of departure from conventional symmetric encryption systems is that the key used to first encrypt the plaintext and then decrypt the ciphertext (the “encryption key”) is divided into two or more distinct subcomponents. One component of the encryption key (referred to herein as the “public key”) is provided along with the encrypted ciphertext. A second component of the encryption key (referred to herein as the “private key”) is known only to the encrypting party and to the one or more parties authorized to decrypt the ciphertext. A mathematical algorithm used to meaningfully integrate and utilize the information contained in the public and private components of the encryption key is also preferably known only to the encrypting party and the authorized decrypting parties. Depending on the level of security that is desired, such as when viewed in the context of who the parties to the transaction are, what the value of the information contained in the encrypted documents is (presently and over time), and how much time and effort must be expended to either decipher the encryption key, the ciphertext, or both, alternate procedures having varying levels of safety and security may be utilized in, or to grant or restrict access to, the private component of the encryption key.

The “public key” is essentially an array of random numbers and the “private key” is a block of random data. The random numbers in both the public and private keys may be generated using random number generation means known in the art. Depending on the level of security and randomness that is desired, either or both of the public and private keys may be generated for each electronic file to be encrypted or else used to encrypt more than one file. Generating new public and/or private keys for each electronic file greatly increases the difficulty of a hacker in deciphering the code and accessing the encrypted files. Generating a new private key for each encrypted electronic file is, in some ways, at least partially akin to a “one-time pad” encryption system, which is theoretically the most secure encryption system possible.

To restrict availability to unauthorized parties, the private key and encryption algorithm may be embedded or hard-coded within the computer-executable instructions or software used to decrypt and view the decrypted file. Alternatively, the decrypting party may be required to obtain the private key and at least a portion of the encryption algorithm at the time of decryption, such as by means of a password-protected login procedure over a secure channel. The latter would more securely protect the security and integrity of the file in the event that an unauthorized third party were to intercept the encrypted file and public key, and were to somehow secure a copy of the viewing software.

In an exemplary encryption process within the scope of the invention, the original data stream, or “cleartext,” is encrypted one byte (eight bits) at a time by performing an “exclusive-or” (XOR) process for each byte against one or more random number values taken from the public key. The private key, by means of a mathematical algorithm, is used to select one or more random numbers from the public key each time a byte of the data stream is encrypted. The encrypted bytes are stored as the encrypted data. In an exemplary method for storing and sending the encrypted file, the public key is stored with the encrypted data stream to yield a unique file type that is decrypted and displayed using special software provided by the encrypting party.

Without limiting the general nature of the invention, the inventive encryption processes are especially well suited in the case where a single encrypting party wishes to securely send encrypted files to a number of different receiving parties. An example is where a central repository of medical records, which are typically hand-written then converted and saved in graphic form (e.g., as a TIFF file), wishes to securely send a medical record to one or more receiving requesting parties who are authorized to view the medical record in question over a nonsecure channel, such as the Internet.

In an exemplary decryption process, the ciphertext is decrypted using the same public and private keys used to encrypt the plaintext. So long as the same mathematical algorithm is used for decryption that was used for encryption, and because the XOR process is reversible, the encrypted data may be decrypted (e.g., one byte at a time) by means of the same random number values from the public table using the same XOR process to yield the original cleartext.

In the case where the ciphertext is an encrypted graphic file, the decryption algorithm may advantageously be integrated within a specialized viewing program that integrates decryption and display of the graphic file. In a preferred method for ensuring the security and integrity of the original document, the viewer (e.g., a TIFF viewer) supplied to the decrypting party will prevent, or at least make it extremely difficult and illegal, for the viewing party to alter the decrypted image file in any way, and/or save the decrypted cleartext file, and/or encrypt cleartext files, and/or display any file that is not an encrypted TIFF file stored together with the public key. Such alterations will at least make it difficult to pass off an altered file as the originally sent file. Additional features of the preferred viewing program will be discussed more fully below.

Accordingly, it is an object of the invention to provide improved encryption and decryption methods and systems specifically tailored to prevent unauthorized capture or access to a sensitive medical record transmitted over a public or quasi-public communications channel, such as the Internet.

It is a further object to provide encryption and decryption methods and systems which not only prevent unauthorized capture or access to sensitive records sent via the Internet or other public channel but which prevent unauthorized alteration of the record in the event that unauthorized access was achieved.

It is an additional object to provide methods and systems for the encryption of files and subsequent decryption and display which not only prevent unauthorized access or alteration of an electronic document but which also indicate to the custodian of the record if someone had, in fact, altered, or attempted to alter, the electronic document.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2A is a schematic diagram illustrating an exemplary encryption system according to the invention;

FIG. 2B is a schematic diagram illustrating an exemplary decryption system according to the invention;

FIG. 3 is a schematic diagram illustrating an exemplary communication system between an encrypting party and a decrypting party;

FIG. 4 is a schematic diagram illustrating an exemplary system for decrypting and outputting the original electronic file according to the invention;

FIG. 5A is a flow diagram depicting an exemplary process by which an original electronic file is encrypted and then stored as a unique file type according to the invention;

FIG. 5B is a flow diagram depicting an exemplary process by which an encrypted file is decrypted according to the invention;

FIG. 6 illustrates a detailed process according to the invention by which a block of the cleartext is encrypted and/or a block of ciphertext is decrypted; and

FIG. 7 illustrates an exemplary algorithm for serially selecting random numbers from the private key during encryption of each block of cleartext or decryption of each block of ciphertext according to the invention.

### DETAILED DESCRIPTION OF THE INVENTION

I. Introduction and Definitions.

The present invention encompasses novel methods and systems for the encryption, decryption, and output of electronic files. Such methods and systems utilize a symmetrical encryption/decryption key having public and private components that are used for both encryption and decryption. The public component of the encryption key is attached to the encrypted file to yield a unique file type, which can be read only by someone having the correct software. Specialized viewing software may integrate the decryption algorithm so that a decrypting party can decrypt and view the encrypted file in a single step. The software may advantageously be configured to prevent the viewing party from saving, altering or sending the decrypted plaintext file to an unauthorized party. The inventive methods and systems are particularly suitable for transmitting encrypted files over the Internet.

The invention provides for secure transmission of sensitive or confidential documents by a centralized repository to a wide variety of different receiving parties, or “requestors.” An example includes the transmission of medical records, which are typically hand-written and which are most often digitized as graphic files, typically as a “Tagged Image Format File” (TIFF). Of course, the inventive encryption methods and systems may be used to protect the security of any sensitive or confidential electronic document, whether in graphic or text form.

Although the term “encryption algorithm” may normally refer to the specific mathematical algorithm used in the actual encryption and/or decryption processes, for simplicity and brevity this term shall also include, as a subcomponent, the mathematical algorithm used to meaningfully utilize and integrate the public and private components of the encryption keys used according to the invention. The latter algorithm may more specifically be referred to as the “encryption key algorithm,” or simply “the key algorithm.”

Although the term “public key” is typically used in the art to refer to a publicly available encryption key that is given to clients of a central institution for the purpose of encrypting and sending private information from a client to the institution, but which cannot be used to decrypt the encrypted file (i.e., in asymmetric encryption), for purposes of this disclosure and the appended claims, the term “public key” shall refer to the subcomponent of the encryption key that is sent together with the encrypted file from the sender to the receiver of an encrypted file. Thus, the “public key” is not really “public” in the conventional sense but is so described because it is packaged and sent together with the encrypted file, typically over the Internet, such as via a secure HTTPS channel. Moreover, the “public key” is used for both encryption and decryption of electronic files (i.e., in symmetric encryption).

Although the term “private key” is typically used in the art to refer to the decryption key that is only known to the deciphering party in asymmetric encryption, for purposes of this disclosure and appended claims, the term “private key” shall refer to the subcomponent of the encryption key that is not sent with the encrypted file but which is known only to the sender and the receiver of the encrypted file. Thus, access to the “private key” is limited to the encrypting and decrypting parties. Like the public key, the “private key” is also used for both encryption and decryption of electronic files in a symmetric encryption system.

The terms “cipher” or “key” generally relate to both the public key and the private key, but especially refer to the interaction between the public and private keys to yield a single symmetrical cipher or key system used in both encrypting and decrypting electronic files.

The terms “exclusive or” or “XOR” refer to the process by which a first binary number is compared to a second binary number so as to yield a third binary number. For purposes of this disclosure and the appended claims, it shall be understood that the binary equivalent of an integer value is used in the XOR process because this process is unique to binary numbers. Thus, when a block of binary data is “XORed” with an integer value selected from an encryption key, it is to be understood that it is the binary equivalent of the integer value that is really being used in the XOR process.

The term “encrypting party” shall mean the actual person or entity that encrypts a particular plaintext file so as to generate a corresponding ciphertext file, together with any affiliates, agents or representatives. Similarly, the term “decrypting party” shall mean the actual person or entity that decrypts a particular ciphertext file so as to restore the corresponding plaintext file, together with any affiliates, agents or representatives.

II. Systems for Requesting and Providing Digital Copies of Medical Documents.

A. Basic Operating System.

The present invention extends to both methods and systems for encrypting and decrypting electronic files, as well as sending and outputting such files. The embodiments of the present invention may comprise a special or general purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media may include random access memory (RAM), read only memory (ROM), electrically erasable programmable read only memory (EEPROM), compact disc read only memory (CD-ROM), digital video disc (DVD), or other optical disk storage, magnetic disk storage or other magnetic storage devices, or any other medium which can be used to carry or store desired program codes in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium, as would be any medium for transmitting a propagated signal. Combinations of the above should also be included within the scope of computer-readable media. In addition to computer-readable media, computer-executable instructions or data structures may be partly or wholly provided to or sent from a computer in the form of a propagated wave, typically by means of one or more communications connections between two or more computers. Computer-executable instructions comprise, for example, instructions and data which cause a general purpose computer, special purpose computer, or special purpose processing device to perform a certain function or group of functions.

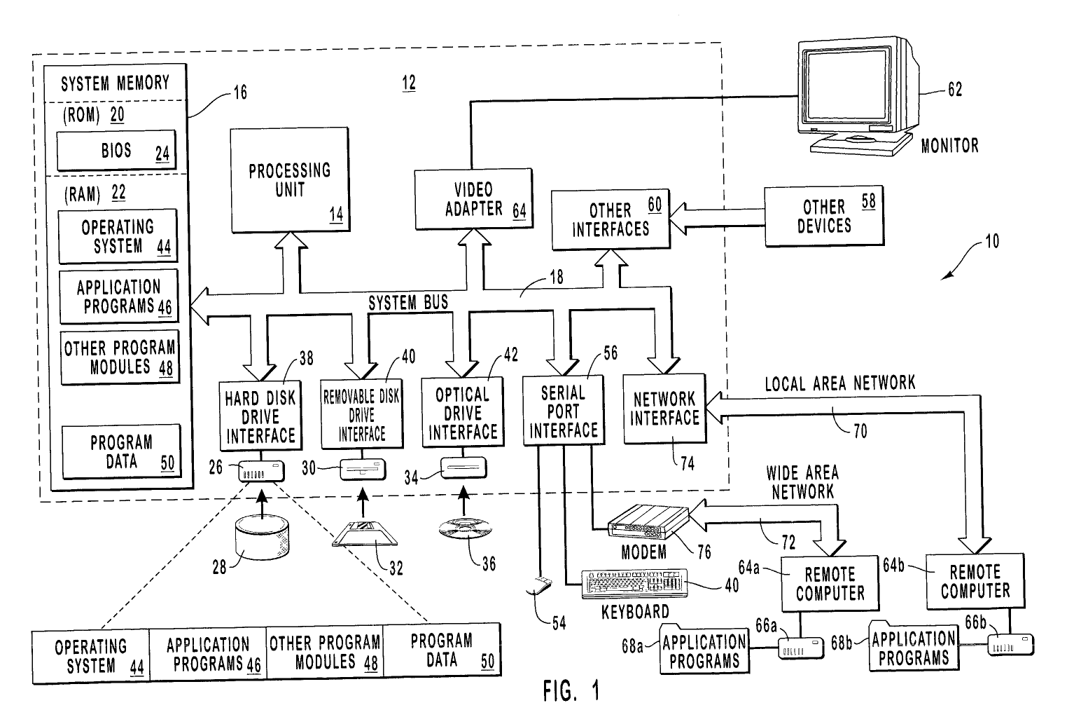

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program-code means for executing steps of the methods disclosed herein. The particular sequences of such executable instructions or associated data structures represent examples of corresponding acts for implementing the functions described in such steps.

Those skilled in the art will appreciate that the invention may be practiced in network computing environments with many types of computer system configurations, including personal computers (PCs), hand-held devices, multi-processor systems, microprocessor-based or programmable consumer electronics, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer system 10, which, in its broadest sense, includes components hardwired or otherwise associated together within a conventional computer box, bundle, or subsystem illustrated by item number 12, together with user interface, communications, and other devices and features located externally to, physically separated from, or otherwise spaced apart relative to the computer bundle or subsystem 12. By way of example, and not limitation, a conventional computer bundle or subsystem 12 includes a processing unit 14, a system memory 16, and a system bus 18 that couples various system components including the system memory 16 to the processing unit 14. The system bus 18 may be any of several types of bus structures including a memory bus or memory controller, a peripheral bus, and a local bus using any of a variety of bus architectures. The system memory includes read only memory (ROM) 20 and random access memory (RAM) 22. A basic input/output system (BIOS) 24, containing the basic routines that help transfer information between elements within the computer system 10, such as during start-up, may be stored in ROM 20.

The computer system 10, typically the computer bundle or subsystem 12, may also include a magnetic hard disk drive 26 for reading from and writing to a magnetic hard disk 28, a magnetic disk drive 30 for reading from or writing to a removable magnetic storage device 32, and an optical disk drive 34 for reading from or writing to a removable optical disk 36 such as a CD-ROM, digital versatile disk, a laser disk, or other optical media. The magnetic hard disk drive 26, magnetic disk drive 30, and optical disk drive 34 are connected to the system bus 18 by a hard disk drive interface 38, a magnetic disk drive-interface 40, and an optical drive interface 42, respectively. The drives and their associated computer-readable media provide nonvolatile storage of computer-executable instructions, data structures, program modules, and other data for the computer 10. Although the exemplary environment described herein employs a magnetic hard disk 28, a removable magnetic disk 32, and a removable optical disk 36, other types of computer readable media for storing data can be used, including magnetic cassettes, flash memory cards, Bernoulli cartridges, RAMs, ROMs, and the like. For purposes of the specification and the appended claims, the term “computer readable medium” may either include one or a plurality of computer readable media, working alone or independently, so long as they singly or collectively form part of a recognizable system for carrying out the processes of the invention.

Program code comprising one or more program modules may be stored on the hard disk 28, magnetic disk 32, optical disk 36, ROM 20, or RAM 22, including an operating system 44, one or more application programs 46, other program modules 48, and program data 50. A user may enter commands and information into the computer bundle or subsystem 12 by means of a keyboard 52, a pointing device (e.g., “mouse”) 54, or other input devices (not shown), such as a microphone, joy stick, game pad, satellite dish, scanner, video player, camera, or the like. These and other input devices are often connected to the processing unit 14 through a serial port interface 56 coupled to the system bus 18. Alternatively, these and other devices 58 may be connected by other interfaces 60, such as a parallel port, a sound adaptor, a decoder, a game port or a universal serial bus (USB). Nonexhaustive examples of “other devices 58” include scanners, bar code readers, external volatile and nonvolatile memory or storage devices, audio devices, video devices, and microphones. A monitor 62 or another display device is also connected to the system bus 18 via an interface, such as a video adapter 64. In addition to the monitor 62, computers typically include other output devices (generally depicted as “other devices 58”), such as speakers and printers.

The computer system 10 may operate in or involve a networked environment using logical connections to one or more remote computers, such as remote computers 64a and 64b. Remote computers 64a and 64b may each be another personal computer, a server, a router, a network PC, a peer device or other common network node, and typically include many or all of the elements described above relative to the computer system 10, although only memory storage devices 66a and 66b and their associated application programs 68a and 68b have been illustrated in FIG. 1. The logical connections depicted in FIG. 1 include a local area network (LAN) 70 and a wide area network (WAN) 72 that are presented here by way of example and not limitation. Such networking environments are commonplace in office-wide or enterprise-wide computer networks, intranets, and the global computer network or “Internet”.

When used in a LAN networking environment, the computer bundle or subsystem 12 is connected to the local network 70 through a network interface or adapter 74. When used in a WAN networking environment, the computer bundle or subsystem 12 may include a modem 76, a wireless link, or other means for establishing communications over the wide area network 72, such as the Internet. The modem 76, which may be internal or external, is typically connected to the system bus 18 via the serial port interface 56. In a networked environment, program modules depicted relative to the computer bundle or subsystem 12, or portions thereof, may be stored in a remote memory storage device (e.g., remote storage devices 66a and 66b). It will be appreciated that the network connections shown are exemplary, and other means of establishing communications over wide area network 72 may be used.

Although computer components are commonly arranged in the form depicted in FIG. 1, with some components of the computer system 10 physically located within, and other components physically located outside, the computer bundle or subsystem 12, it will readily be appreciated that the terms “computer” and “computer system” should be broadly understood to include any or all of the foregoing components in any desired configuration which facilitate carrying out the inventive methods and systems disclosed herein. The terms “computer” and “computer system” may therefore include other common features or components not depicted in FIG. 1.

B. Encryption and Decryption Systems.

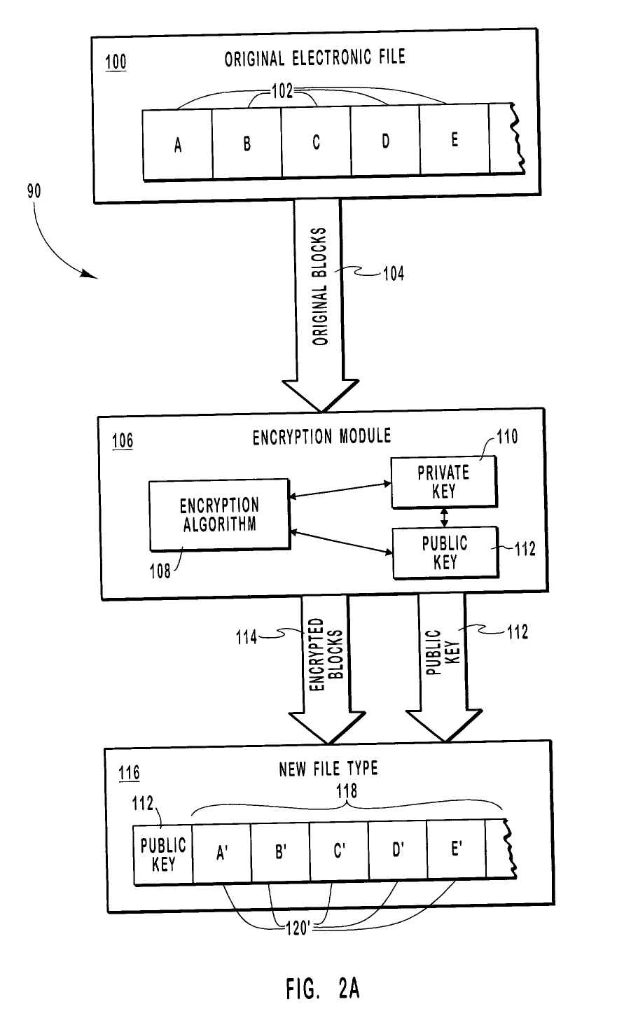

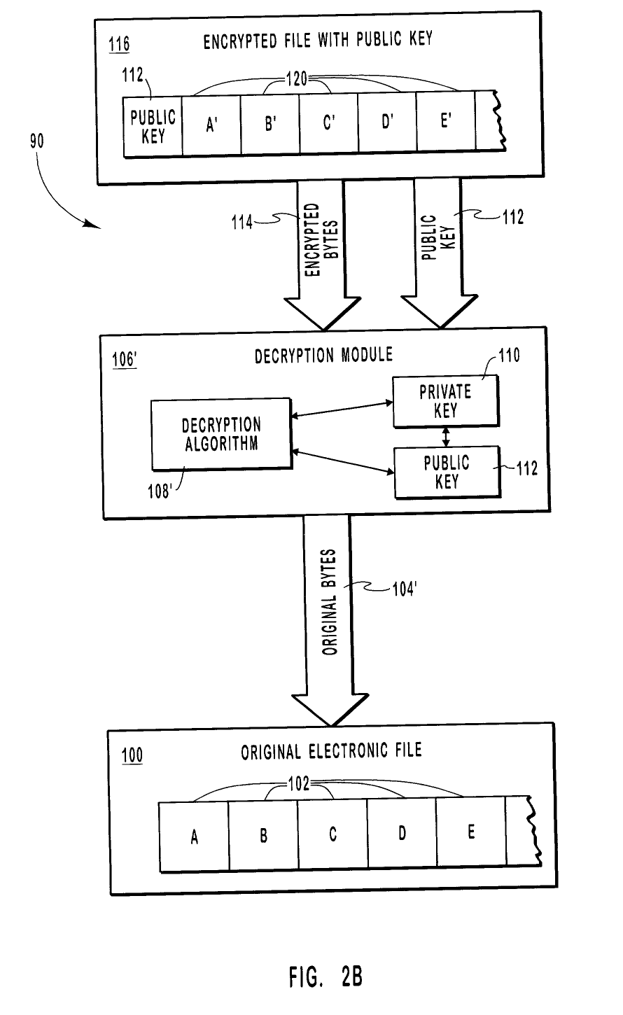

Exemplary encryption and decryption systems within the scope of the invention are depicted more particularly in FIGS. 2A and 2B. FIG. 2A illustrates an inventive encryption system 90 that may be used to encrypt an original plaintext file and then store the ciphertext together with the public key to yield a new file type. The encryption system 90 essentially includes an original electronic file 100, comprising plaintext blocks 102 (e.g., A-E etc.) to be encrypted, and an encryption module 106, comprising an encryption algorithm 108, a private key 110 and a public key 112. Operation of the encryption system 90 yields a new file type 116, comprising encrypted ciphertext 118 and the public key 112, which, although depicted in FIG. 2A, do not strictly constitute part of the encryption system 90. The ciphertext 118 further comprises encrypted blocks 120 (e.g., A′-E′ etc.), which at least partially correspond to plaintext blocks 102 (e.g., A-E etc.).

In a preferred embodiment, the original electronic file 100 will be encrypted one block at a time. FIG. 2A therefore depicts a stream 104 of original plaintext blocks 102 being input from the original electronic file 100 to the encryption module 106. Also depicted is a stream 114 of encrypted blocks 120 being generated by the encryption module 106, as well as the public key 112, which are stored together as part of the new file type 116. The system depicted in FIG. 2A may be embodied by any computing means known in the art, including those depicted in FIG. 1 and described above.

The size of the plaintext blocks 102 to be encrypted can vary according to the desired difficulty level in breaking the cipher. In general, the larger the blocks, the more difficult it is to break the cipher. On the other hand, the size of the encryption key will correspond to the size of the blocks. Thus, the length of the plaintext blocks 102 can be selected to balance the desired level of security (i.e., difficulty in breaking the cipher) against concerns of reducing the storage space, memory and time required to encrypt and decrypt a given file. In an exemplary system according to the invention, the plaintext blocks 102 will comprise one byte (8 bits) of binary data, as will the encrypted blocks 120 and the random number values contained within the public key 112. Nevertheless, it will be readily appreciated that the inventive systems may be generalized so as to be used in encrypting plaintext blocks of any desired size.

The encryption module 106 preferably encrypts the original electronic file 100 to yield the encrypted file 118 by means of the encryption algorithm 108 utilizing numeric information supplied to it by the interaction of the private key 110 and public key 112. Without limiting the general nature of the invention, in an exemplary embodiment within the scope of the invention, the public key 112 provides one or more random numeric values used to encrypt each plaintext block 102 using, e.g., an “exclusive or” (XOR) process, while the private key 110 provides random numeric values used to select, or index, the one or more random values from the public key 112. In other words, while the public key 112 provides the encryption algorithm 108 with the actual random value(s) to XOR with each plaintext block 102 during encryption, the private key 110, according to a special key algorithm embedded within the encryption algorithm 108, tells the encryption algorithm 108 which random value(s) is/are to be selected from the public key 112 during each encryption cycle.

The total number of random number values within the private and public keys 110 and 112 will depend on the level of security that is desired. In general, the greater the number of random values the greater will be the task of breaking the cipher. On the other hand, increasing the total number of random number values of the public key will increase the size of the resulting encrypted file and may increase the time it takes to encrypt and decrypt an electronic file. In general, in the case where blocks of binary numbers are being serially decrypted, it will be preferable for the total number of random numbers to be a power of 2 (e.g., 256, 1024, 2048 or 16,384), according to common convention. In an exemplary system according to the invention, the private key 110 and the public key 112 will each contain a total of 2048 different random number values, serially indexed from 0 to 2047 and randomly selected from possible numbers within a predetermined range.

One weakness in any encryption system is where the key is far shorter (i.e., includes far fewer numbers) than the number of blocks to be encrypted, thus resulting in repetition of the key sequences during encryption. This opens the door to hackers identifying a pattern in the key, thus leaving a way to break the cipher and obtain the information that has been encrypted using the deciphered key. In the present case, even though the total number of random number values within the two keys is typically far less than the number of blocks that are to be encrypted, repetition of the overall key (public plus private portions) is highly unlikely due to the way in which the two keys are mathematically related, as will be discussed more fully below. Even though a hacker may have the public key in plain view, the failure to identify a sequence in the key as a whole will make it very difficult to decipher the private portion of the key.

The ranges of possible random number values within the private key 110 and public key 112 are determined by different criteria. The range of possible random numbers within the private key 110 will generally be determined by the starting and finishing index numbers of the public key 112. Thus, in the case where the public key 112 contains 2048 random numbers, serially indexed from 0 to 2047, the range of possible random numbers within the private key 110 will include integers from 0 to 2047.

On the other hand, the range of possible random numbers within the public key 110 will generally be dependent on the size of the plaintext blocks 102 being encrypted. In the case where the plaintext blocks 102 are one byte in length, the upper range of possible random numbers within the public key 112 will be 255, which is the largest possible integer having 1 byte of binary data (i.e., 255=11111111 in binary code). Because the number 0 (00000000 in binary code) will return the original number in an XOR process, it may be advantageous to limit the range of possible public key values to non-zero integers so as to ensure a numeric change during each XOR process. Thus, in the case where the plaintext is to be encrypted one byte at a time, the range of possible random numbers within the public key 112 will preferably include integers from 1 to 255. Of course, randomly returning the same number for a block of plaintext from time to time will still yield an encrypted file that is difficult to decipher because the vast majority of surrounding blocks of ciphertext will have been altered from the original plaintext. Hence, the set of random numbers within the public key will be randomly or otherwise selected from a set bounded below by 0 or 1 and bounded above by 255, or the largest integer value corresponding to the binary blocks being encrypted/decrypted.

Reference is now made to FIG. 2B, which illustrates an exemplary decryption system 92 according to the invention that may be used to decrypt the new encrypted file type 116 generated using the encryption system 90 of FIG. 2A. The decryption system 92 essentially includes the new file type 116, comprising the public key 112 and encrypted blocks 120 of ciphertext 118 to be decrypted, and a decryption module 106′, comprising a decryption algorithm 108′ and the private key 110 and public key 112 utilized in the encryption module 106 described above with respect to the encryption system 90. Operation of the decryption system 92 restores the original plaintext file 100, which, although depicted in FIG. 2B, does not strictly constitute part of the decryption system 90. The decryption algorithm 108′ is similar to the encryption algorithm 108, except that the encryption algorithm 108 ultimately stores the public key 112 together with the encrypted ciphertext file 118, while the decryption algorithm 108′ discerns and distinguishes the public key 112 from the encrypted ciphertext 120.

As in encryption, the encrypted file 118 is preferably decrypted one block at a time. FIG. 2B therefore depicts a stream 114′ of encrypted blocks 120 (e.g., A′-E′ etc.) being input from the encrypted file 118 to the decryption module 106′. The new file type 116 provides the public key 112 to the decryption module 106′. Also depicted is a stream 104′ of plaintext blocks 102 (e.g., A-E etc.) being generated by the decryption module 106′, which together yield the original plaintext electronic file 100. The system depicted in FIG. 2B may be embodied by any computing means known in the art, including those depicted in FIG. 1 and described above.

As plainly seen by comparing the encryption and decryption systems depicted in FIGS. 2A and 2B, respectively, the two systems are virtual mirror images of each other, thus reflecting the fact that the encryption and decryption systems of the present invention are essentially “symmetric” as that term is known in the art. Whereas one system produces the opposite result of the other system (i.e., encryption versus decryption), both utilize the same private and public keys 110 and 112. Accordingly, the discussion set forth above with respect to the total number and range of possible random integer values for the private and public keys 110 and 112 when implementing the encryption system 90 depicted in FIG. 2A also applies to the implementation of the decryption system 92 depicted in FIG. 2B.

The reason that the same private and public keys 110 and 112 can be used in both the encryption system 90 and the decryption system 92 is because the XOR process is reversible. That is, after performing an XOR process on an original number to yield a new number, subsequently performing the same XOR process on the new number restores the original number. Hence,

If A XOR B=C, then C XOR B=A.

For example, 25 XOR 233=240, so that 240 XOR 233=25, which is better understood by the binary numbers depicted below:

$$XOR \begin{matrix} 25 : 00011001 \\ \underline{233 : 11101001} \\ 240 : 11110000\end{matrix} XOR \begin{matrix}240 : 11110000 \\ \underline{233 : 11101001} \\ 25 : 00011001\end{matrix}$$

The XOR process compares two bits at a time and gives a result of 0 when the bits equal each other, and a result of 1 when the bits do not equal each other. Serial XOR processes are also reversible, hence,

If A XOR B, C, D, E=F, then F XOR B, C, D, E=A

For example, 57 XOR 254, 16, 92, 133=14, so 14 XOR 254, 16, 92, 133=57, which is better understood by the binary numbers depicted below:

$$XOR \begin{matrix} 57 : 00111001 \\ \underline{254 : 11111110} \\ 199 : 11000111\end{matrix} XOR \begin{matrix} 14 : 00001110 \\ \underline{254 : 11111110} \\ 240 : 11110000\end{matrix}$$

$$\begin{matrix}XOR & \underline{16 : 00010000} \\ & 215 : 11010111\end{matrix} \begin{matrix}XOR & \underline{16 : 00010000} \\ & 224 : 11100000\end{matrix}$$

$$\begin{matrix}XOR & \underline{92 : 01011100} \\ & 139 : 10001011\end{matrix} \begin{matrix}XOR & \underline{92 : 01011100} \\ & 188 : 10111100\end{matrix}$$

$$\begin{matrix}XOR & \underline{133 : 10000101} \\ & 14 : 00001110\end{matrix} \begin{matrix}XOR & \underline{133 : 10000101} \\ & 57 : 00111001\end{matrix}$$

The XOR process is also commutative, which means that the same result is obtained regardless of the order of operation, hence,

If A XOR B, C=F, then A XOR C, B=F

This property of XOR is not necessarily a desirable property for the purposes of encryption and decryption because it makes the ciphertext easier to decrypt. Thus, it may also be beneficial to apply an additional mathematical operator in combination with XOR that will make the process noncommutative. For example, adding or subtracting 1 or changing or all of the bits to their complement (i.e., 0 for 1 and vice versa) would render the process noncommutative. Thus, the XOR process may advantageously be modified or combined with another mathematical process so that it is not commutative.

Exemplary methods for implementing the encryption and decryption systems according to the present invention (including the encryption and decryption systems 90 and 92 depicted in FIGS. 2A and 2B, respectively, and described herein) will be discussed more fully below.

C. Communication System Between Encrypting and Decrypting Parties.

The inventive methods and systems for encrypting and then decrypting electronic files according to the invention may be implemented in any desired manner, and are well suited for the case where a single encrypting party wishes to send a number of different encrypted files to various receiving parties. The communication interface between the sending and receiving parties may comprise any desired communication system known in the art or which may be developed in the future. Examples include dedicated phone lines, the Internet, ordinary mail and the like.

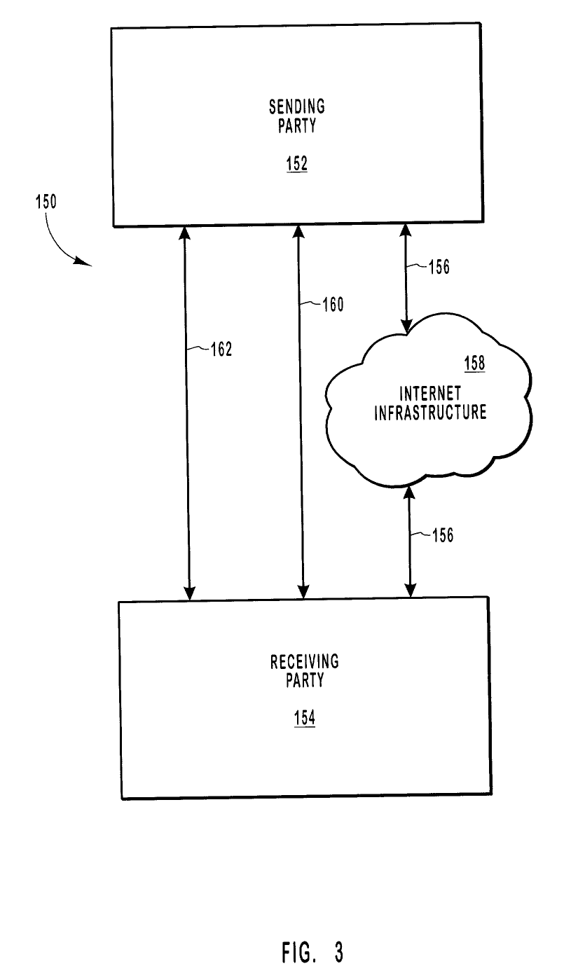

FIG. 3 illustrates an exemplary communication system 150 between a sending party 152 (typically the encrypting party) and a receiving party 154 (typically the decrypting party). One exemplary communication channel comprises a less secure communication channel 156 that involves, or passes through, the Internet infrastructure 158. A secure socket layer (e.g., via HTTPS) can be used to more securely communicate between the sending party 152 and the receiving party 154. Another example is a dedicated phone line 160 or secure digital channel. Another is a courier service 162, such as ordinary mail, used to transmit hard or tangible copies of appropriate storage media containing digital information. The dedicated phone line 160 generally provides more security than a communication channel 156 involving the Internet 158. Likewise, a courier service 162 generally provides greater security compared to a dedicated phone line 160. The preferred communication channel will depend on the information being shared and the security that is desired.

The encrypted files and their respective “public keys” may be sent over any desired communications channel known in the art, including both secure and nonsecure channels. One presently preferred communication system is over the Internet 158. Because the security of the encryption and decryption systems of the invention are dependent on maintaining the secrecy of the private key rather than the public key, and because the encrypted file cannot be decrypted without the private key (at least not without tremendous effort), the new file type comprising an encrypted file 118 and corresponding public key 112 (FIGS. 2A and 2B) may be sent over a nonsecure channel. Because the Internet is presently the least expensive nonsecure channel over which to send electronic data, it presently constitutes the preferred system for transmitting an encrypted file and its public key to the requesting third party. Nevertheless, the encrypted file may be sent by other means, such as over a secure channel 160 or by courier service 162.

On the other hand, the system for communicating the private key to the decrypting party must generally be secure so as to prevent interception by unauthorized third parties. In the case where a single private key is used to encrypt and then decrypt a plurality of different electronic files, the private key may be sent to each of the decrypting parties using a secure channel, such as through ordinary mail 162 via a CD-ROM, floppy disk or other appropriate storage medium. An advantage of this system is that is allows a repeat customer to continually decrypt each new encrypted file using the same private key. A weakness of this approach is the ability of a rogue customer to simply copy the private key and/or share it with unauthorized third parties.

Another exemplary system for communicating the private key is a dedicated phone line 160 between the encrypting and decrypting parties that may be accessed through a password-protected login procedure. A weakness of this approach is the ability of an eavesdropper to intercept the private key using a wiretap or other surveillance method. A private key that is used to encrypt and decrypt many files may be prone to being intercepted and used to decrypt files that are subsequently sent by the same encrypting party. Nevertheless, so long as the secrecy of the private key is carefully maintained, encryption and decryption systems using a single private key to encrypt many files can be very secure, particularly if the overall key (public and private components) is difficult to decipher. One way to increase the difficulty of intercepting the private key is to use an additional encryption algorithm and associated key to encrypt the private key, thereby creating additional hurdles for a motivated hacker to overcome.

In another embodiment of the invention, the private key is regenerated periodically so that a hacker would have to intercept each new private key as it is generated in order to decipher the encrypted files. In the most secure system, a new private key is generated for each new file that is encrypted, thus requiring a hacker to intercept and/or decipher the private key each and every time a new file is encrypted and sent from the encrypting party to the authorized decrypting party. In theory, this approach at least partially resembles a “one-time pad,” which is theoretically the most secure encryption system possible.

In a true one-time pad system, the key is at least the same length as the message being encrypted, so that the key sequence is never repeated. In addition, the key is available only to the encrypting and decrypting parties. As stated above, the huge variability inherent in how the private and public keys operate together make the chance of repetition of the overall cipher during encryption very rare. This makes it very difficult and time-consuming for a hacker to decipher the private key. Moreover, because a deciphered private key can be used to decrypt only a single encrypted document where a new private key is generated for each encrypted file, there may be very little incentive for a hacker to expend the time and resources necessary to decipher any particular private key. The primary weakness in this encryption system would be in the ability of a hacker to intercept the private key during transmission from the encrypting party to the decrypting party. Once again, a dedicated phone line requiring a password-protected login procedure would appear to provide adequate protection from interception so long as the dedicated phone line was not bugged. Of course, additional layers of protection, such as encrypting the private key and/or public key using a second secure key known only to the encrypting and decrypting parties, may make it costlier in terms of time and resources to decipher the encrypted keys and associated electronic file than the value of the information contained within the encrypted file. This alone may deter most, if not all, hackers from even caring to decipher the private key and associate encrypted file.

D. Controlled Output System for Decrypted Files.

Notwithstanding each of the foregoing systems for securely encrypting and then sending an encrypted file to an authorized third party while carefully maintaining the security of the private key(s), care must be taken to prevent unauthorized access to the decrypted file. Accordingly, a preferred system for decrypting an encrypted file will also include safeguards that will prevent (or at least make it substantially difficult for) the decrypting party to copy, alter or send the decrypted plaintext file. Because the electronic file is encrypted, it will be virtually impossible to view anything other than an apparently corrupt file using commercially available software, such as standard word processing programs, graphic viewing programs, or spreadsheet programs.

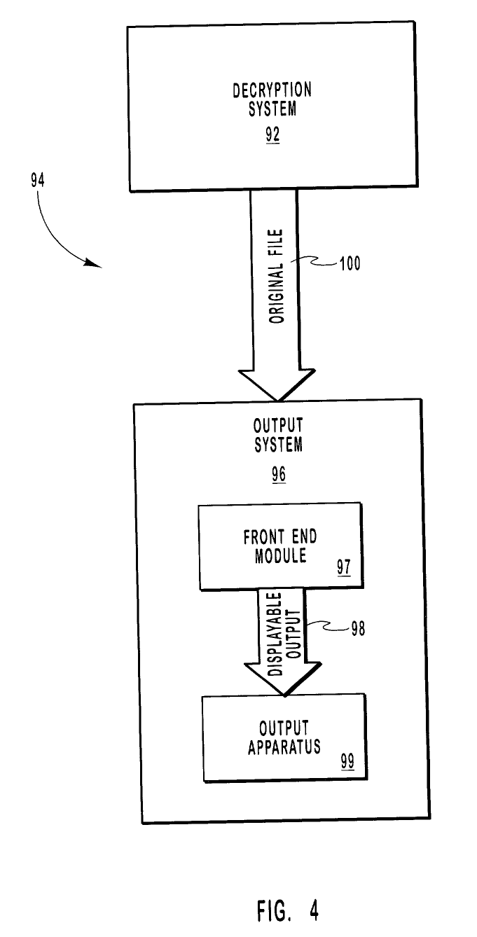

In a preferred embodiment according to the invention, the software that is necessary to decrypt the file, including the decryption module 106′, will preferably be integrated together with an output or viewing system that does not allow the viewing party to copy, alter or send the decrypted plaintext file. FIG. 4 illustrates an integrated decryption/output system 94 that includes the decryption system 92 and an output system 96. The decryption system 92 provides the decrypted plaintext, or original file 100, to the output system 96, which further includes a front end module 97 for decoding, organizing or otherwise making logical sense of the original plaintext file 100, which sends displayable data 98 to an output apparatus 99 for display or other method for outputting the displayable data 98.

In a preferred embodiment, the front end module 97 may be configured so as to severely limit the ability of a decrypting party to copy, alter or send the original plaintext file 100. The software may be limited, for example, to simply supplying an electronic signal for display to a monitor or printer. To be sure, a sophisticated hacker working for the decrypting party might be able to find a way to overcome the barriers erected to prevent copying, altering or sending the decrypted file. Of course, having a mole or spy in any organization would defeat virtually any security system. In most cases, the people typically assigned the task of decrypting an encrypted file in, e.g., an insurance company, hospital, law firm or government bureaucracy, should be carefully screened and trusted individuals.

In the case where the encrypted file comprises part of a new file type, such as new file type 116 (FIGS. 2A and 2B), that includes the public key 112 appended to the front, back, middle or other location within the encrypted file 118, the decryption/output software will advantageously know where to find the public key 112 from among the rest of the electronic data corresponding to the actual encrypted file 118. In a present embodiment, the public key 112 is appended to the front of the file, and the new file type 116 is identified by a unique identifying suffix appended to the file name (e.g., Corel Word Perfect® documents are appended with the suffix “.wpd” while Microsoft Word® documents are appended with the suffix “.doc”).

Appending the new file type with the unique appendix serves at least two purposes. One is that conventional software programs will not recognize this unique file type, thus providing at least a first layer of confusion to a potential copier. Another is that the software required to decrypt and output this unique file type will work only for files having the unique suffix appended thereto, thus making the software of no value to the decrypting party for tasks other than decrypting and displaying the unique file types bearing the proper suffix. This will also tend to prevent unauthorized copying of the decryption/output software. In any event, because the decryption/output software is programmed so as to first identify the public key and then decrypt the remaining electronic file using the associated private key, it is incapable of displaying anything other than corrupt information unless the file being acted upon has been encrypted according to the systems and methods disclosed herein.

One way to determine whether a file has been altered would be for the viewer to validate the file in question against the copy stored or owned by the encrypting party, typically through an SSL connection. For example, additional numeric information specific to a particular file (i.e. a digital signature) could be stored together with, or as part of, the private key. If the signature information of the file in question does not match the signature information for that file in the possession of the encrypting party, then the file in question has been altered from the original version. Such a scenario would require at least the signature portion of the private key to be unique for each encrypted file.

In the case where the original file is in graphic form, such as a TIFF file, the output program, in addition to decrypting the encrypted file portion of the new file type, will advantageously be capable of decoding and displaying and/or printing the TIFF or other graphic file (e.g., GIF, JPEG, or BMP). However, it will preferably not provide the decrypting party with the ability to copy, alter or send the decrypted plaintext file. Though obviously restricted in terms of flexibility and features, the limited number of features of the preferred output program make it less cluttered, more intuitive, and easier to use.

III. Methods for Encrypting and Decrypting Files.

Exemplary methods for encrypting and decrypting electronic files according to the invention should be readily apparent from reading the descriptions of the systems set forth above. Such methods generally include serially encrypting blocks of electronic data (e.g., binary data) using the public and private keys, saving the encrypted blocks, preferably together with the public key, sending the encrypted file to an authorized decrypting party, serially decrypting blocks of the encrypted file using the public and private keys, and outputting the original file. They also include specific algorithms for navigating through, or integrating, the public and private keys during each encryption or decryption sequence per block of electronic data.

A. Generation of Encryption Keys.

Before a file can be encrypted, public and private keys must be provided. The public and private keys each contain serially indexed integer values within predetermined ranges. The number and range of integer values, as well as their randomness, will depend on the level of security that is desired for encryption and decryption of a given file. An exemplary process for generating a key includes the steps of (1) determining how many integer values to include, (2) assigning a sufficient number of indexes to accommodate each integer value, and (3) serially filling each index with a randomly or pseudo-randomly generated integer values within the specified range.

The integer values may be generated using any random number generator known in the art, with the caveat that some random number generators are less random than others. Less sophisticated “random number” generators may actually create patterns that are discemable to hackers. The more “random” the string of random numbers is, the more secure the key will be. A common random number generator uses the clock to generate a seed value to begin the random number generation process. Although randomly selected integer values provide for a more secure cipher, it is certainly within the scope of the invention to include integer values that are not totally random.

B. Encrypting and Decrypting Electronic Files.

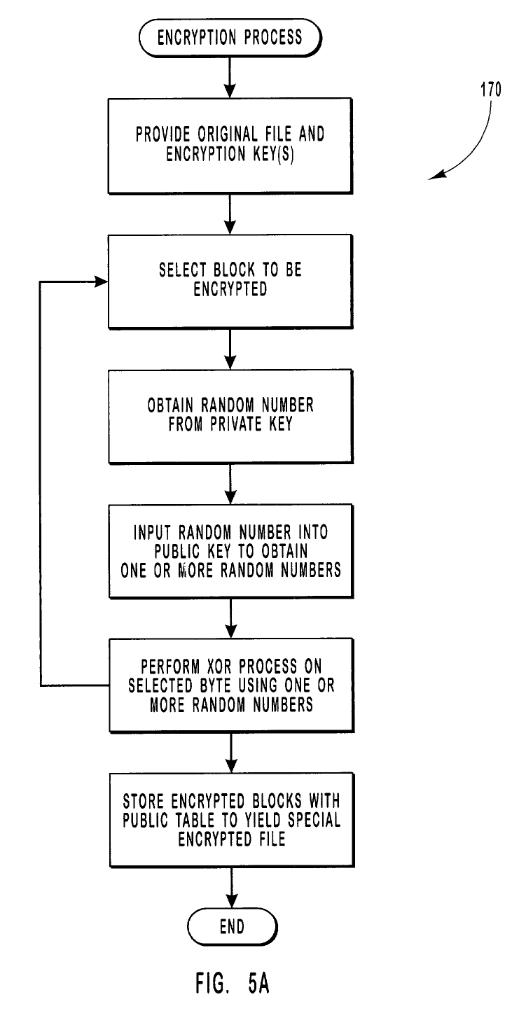

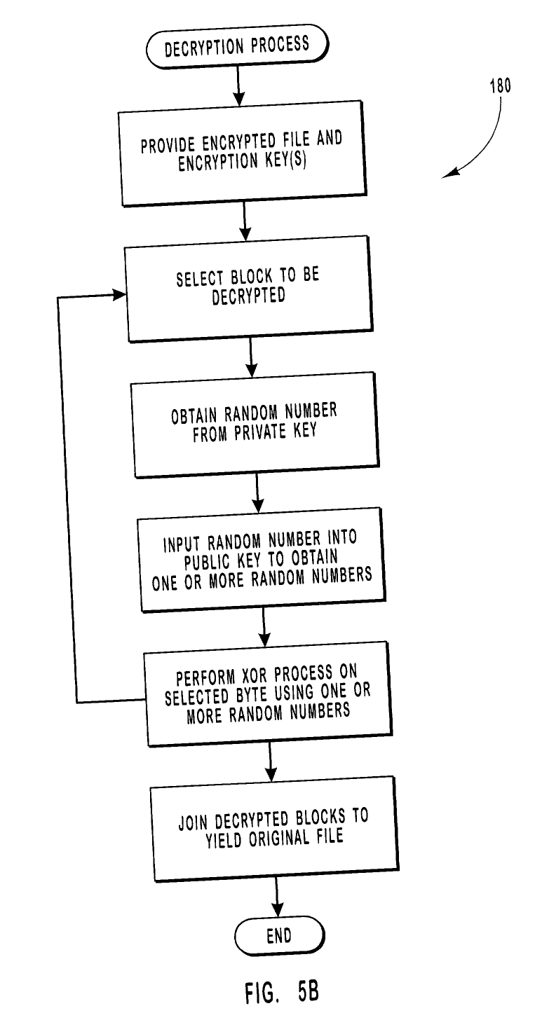

FIG. 5A illustrates an exemplary encryption process 170 that generally outlines general steps for encrypting files within the scope of the present invention. In a first step, an original file is provided together with corresponding public and private keys. A block of cleartext is selected for encryption. A first random number is selected from the private key and then input into the public key in a manner so as to obtain one or more random nunbers. The private key supplies an index number for input into the public key to obtain the one or more random numbers. The one or more random numbers from the public key are then used to encrypt the block of cleartext by means of an XOR process. This process is repeated until the entire plaintext file has been encrypted. The encrypted blocks are stored together with the public key to form a unique file type, preferably including a unique suffix identifiable by special decryption software used to later decrypt the encrypted ciphertext.

In a preferred embodiment, a unique public key will be generated and provided with each new original plaintext file to be encrypted. The private key may be used to encrypt either one or a plurality of files. In general, generating a new private key for each new plaintext file to be encrypted yields a more secure encryption process.

FIG. 5B illustrates an exemplary process for decrypting the ciphertext generated by the process illustrated in FIG. 5A, and is essentially the same, or mirror image of the encryption process. In a first step, an encrypted file is provided together with corresponding public and private keys. A block of ciphertext is selected for decryption. A first random number is selected from the private key and then input into the public key in a manner so as to obtain one or more random numbers. The private key supplies an index number for input into the public key to obtain the one or more random numbers. In a preferred embodiment, the random numbers selected from the private and public keys for any given block of ciphertext will be the same as those used to encrypt the block of cleartext corresponding to that block of ciphertext. The one or more random numbers from the public key are then used to decrypt the block of ciphertext by an XOR process. Because the XOR process is reversible, performing an XOR process on the ciphertext using the same random numbers used to create the ciphertext restores the plaintext block. This process is repeated until the entire ciphertext file has been decrypted and the original plaintext file has been restored.

The algorithm used for encryption and decryption includes as a subcomponent a mathematical relationship that allows the private and public keys to meaningfully interact with each other in the same way during encryption and decryption. Because the encryption and decryption systems according to the invention are symmetrical, the same algorithm used to encrypt the plaintext file will also preferably be used to decrypt the encrypted file, or ciphertext. Accordingly, the algorithm used to integrate the private and public keys together will be known to both the encrypting and decrypting parties, and preferably to no one else.

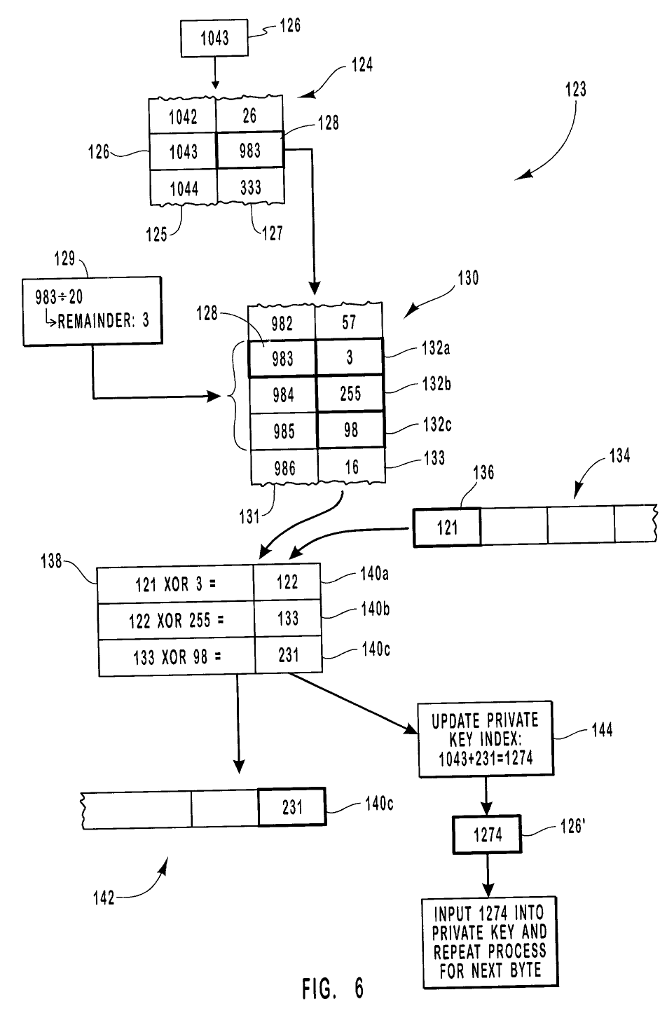

FIG. 6 illustrates an exemplary algorithm or method 123 used to integrate the private and public keys together during encryption and decryption. The first step involves selecting a random number value from a private key 124 that includes an index 125 and a list 127 of corresponding random numbers. According to a predetermined algorithm, to be discussed below, an index position 126 (e.g., 1043) is input into the private key 124 in order to obtain a corresponding random value 128 (e.g., 983). The random number 128 is then input into a corresponding public key 130 that includes an index 131 and a list 133 of corresponding random numbers in order to obtain one or more random numbers. Although it is within the scope of the invention to select only one random number from the public table 130 for encrypting each block of electronic data, it will be preferable to select one or more random values in order to introduce greater randomness into the XOR process and the resulting encrypted block.

As an example of how to determine how many random numbers to select from the public key 130, the random number 128 selected from the private key may be used to determine how many random numbers 132 to select from the public key 130. As depicted in FIG. 6, the random number 128 (e.g., 983) is divided by a predetermined divisor (e.g., 20) and the resulting remainder 129 (e.g., 3) is used to determine how many total random values to select from the public key 130. Although the random numbers may be selected in any desired manner or sequence from the public key 130, in an exemplary method, the random number 128 selected from the private key (e.g. 983) is the beginning index position of the public key 130. Additional random numbers are selected serially by moving to the next successive index position until the predetermined number of random numbers corresponding to the remainder 129 (e.g., 3) having been selected from the public key 130. Hence, according to the example illustrated in FIG. 6, the three random numbers 132a, 132b, and 132c selected from the public table 130 correspond to index positions 983-985, respectively.

The three random numbers 132a-c (e.g., 3, 255 and 98) selected from the public table 130 are then used to encrypt a block 136 (e.g., 121) of the cleartext 134 using an XOR process 138. For example, 121 XOR 3=122, which is a first intermediate encrypted block 140a; 122 XOR 255=133, which is a second intermediate encrypted block 140b; and 133 XOR 98=231, which is the final encrypted block 140c. The final encrypted block 140c is stored together with other encrypted blocks as part of an encrypted file 142. Upon encrypting a block of the original file, process 123 is then repeated for the next block.

The first step of repeating the process 123 for the next block involves updating the index of the private key. Although this may be performed using any desired mathematical relationship, in an exemplary method of the invention, an updating step 144 is carried out by adding the numeric value of the encrypted block 140c to the original index position 126 (e.g., 1043) to yield a new index position 126′ (e.g., 1043+231=1274). The new index position 126′ is then input into the private key 124 during the next iteration of the encryption process 123. As will be discussed more fully below, when a newly determined index position exceeds the number of index positions in the private key, the index position is reset to the starting position (e.g., 0), and a preselected increment (e.g.,, 1) is added to prevent repetition and introduce additional randomness.

In the case where the data stream is to be encrypted one byte at a time, the random numbers selected from the public key will be in a range inclusive of 1 to 255. The number “0” is typically not used because XORing with the number “0” does not change the original value.

C. Updating the Private Key.

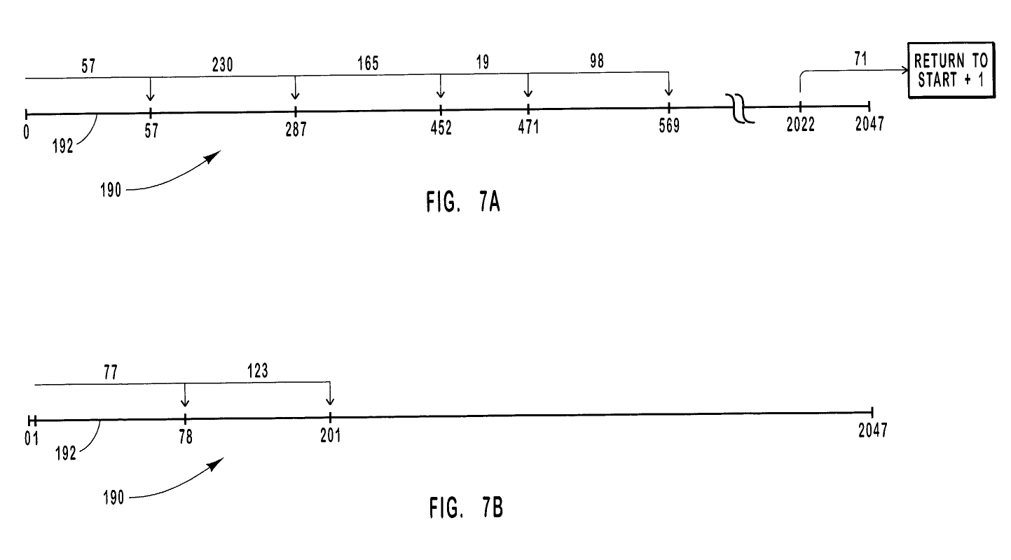

An exemplary process for updating the index position for the private key during each iteration of the encryption or decryption processes according to the invention is illustrated in FIGS. 7A and 7B. When encrypting or decrypting the first block in an electronic file, the random number corresponding to index position 0 is selected and input into the public table, as described elsewhere, to obtain one or more random numbers used to encrypt or decrypt the first block. In order to prevent a string of repetitive data from having the same repetitive pattern in the encrypted result, it may be advantageous to update the index position in a more random manner than simply adding 1 or some other pre-selected number to the index position.

As shown in FIG. 7A, a presently preferred way to randomly update the index 192 of the private key 190 is to add the encrypted block value to the previous index position. Hence, if encrypting the first block of cleartext yields 57 as the encrypted block, 57 is then added to 0 such that 57 is the next index position used to select a random number from the private key 190 for the next iteration of the encryption process. Each of the successive encrypted block values (e.g., 230, 165, 19, 98, etc.) is used to incrementally update the index position (e.g., 287, 452, 471, 569, . . . 2022) for each successive iteration of the encryption process.

At some point, when the next calculated index position (e.g., 2022+71) is greater than the highest index position (e.g., 2047), the next actual index position is selected by returning to the beginning index position, plus some predetermined increment, e.g., 1, as illustrated in FIG. 7B. Thus, when the predetermined increment is 1, the position is reset to the beginning index position (i.e., 0) but offset by the number of times the position has gone past the ending index position of the private key. When the offset exceeds the ending index position of the private key, it is reset to 0 or some other number. If repetition becomes a problem, the key sizes can be increased to delay the appearance of repetitive patterns in the encrypted result.

In order to restore the plaintext during encryption, the private key index position is updated in the same manner as during encryption so that the same random numbers used to encrypt a block of data is used to decrypt the corresponding block of ciphertext. In this manner, the original cleartext is restored in a symmetric encryption/decryption process.

D. Outputting the Decrypted File.

After an encrypted file has been decrypted so as to restore the original plaintext file, the contents may be displayed, saved, manipulated, duplicated, altered or shared using any appropriate software known in the art for the particular file type in question. Nevertheless, in order to preserve the confidentiality and integrity of the original file, it may be preferable to limit the ability of the decrypting party to save, share or alter the data contained therein.

Accordingly, in a preferred method for outputting the decrypted file the decrypting will be limited to merely viewing and/or printing out a hard copy of the decrypted file. This may be accomplished by providing the decrypting party with special software, as described herein, that integrates the decryption and outputting processes so as to provide the decrypting party with only limited access to the information contained in the decrypted file. The software will first perform the decryption process described herein using the private and public keys together with the decryption algorithm, followed by a controlled outputting process that preferably provides no options to the end user that would permit copying, alteration or sharing of the decrypted file. Even if someone were to succeed in altering the information contained within the original plaintext file, any forgery or fraud could be easily detected by comparing the altered copy with the originally stored file.

The special software may be supplied by courier in the form of a tangible recorded copy (e.g., a CD-ROM or floppy disk) or by means of a secure, password-protected network communication between server and client computers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A method for protecting an electronic file from unauthorized access, copying or alteration, comprising:
(a) providing a plaintext file that includes blocks of original binary data to be encrypted, said blocks having a given length and a maximum possible integer value;
(b) providing a first key that includes a number of indexed integer values selected from a set bounded below by 0 or 1 and above by the maximum possible integer value of the blocks of binary data to be encrypted;
(c) providing a second key that includes a number of indexed integer values selected from a set bounded below by 0 and above by the predetermined number of indexed integer values included in the first key;
(d) providing a key algorithm that relates the first and second keys together;
(e) selecting from the plaintext file a block of binary data to be encrypted;
(f) selecting, according to the key algorithm, an integer value from the second key;
(g) inputting, according to the key algorithm, the integer value selected from the second key into the first key so as to obtain one or more integer values;
(h) performing an XOR process on the block of original binary data using the one or more integer values obtained from the first key so as to generate a block of encrypted binary data; and
(i) repeating steps (e)-(h) until a desired portion the plaintext file has been encrypted so as to yield a ciphertext file including blocks of encrypted binary data.

2. A method as defined in claim 1, wherein the blocks of original binary data to be encrypted are one byte in length and have a maximum numeric value of 255 and wherein the integer values included in the first key are selected from a set bounded below by 0 or 1 and bounded above by 255.

3. A method as defined in claim 1, wherein the integer values contained in the first key and the second key are random or pseudo-random numbers.

4. A method as defined in claim 1, wherein the number of integer values obtained from the first key and used in encrypting the block of original binary data is determined by a remainder value generated by dividing the integer value selected from the second key by a predetermined divisor.

5. A method as defined in claim 4, wherein the number of integer values within the first key is 2048, wherein the number of integer values within the second key is 2048, and wherein the predetermined divisor used to generate the remainder value is 20.

6. A method as defined in claim 4, wherein the number of integer values obtained from the first key is equal to the remainder value except when the remainder value equals 0.

7. A method as defined in claim 1, wherein the first integer value selected from the second key when encrypting the first block of original binary data is selected from index position 0, wherein each successive integer value selected from the second key when encrypting each successive block of original binary data is selected by first updating each immediately preceding index position by the value of the immediately preceding block of encrypted binary data and then selecting the integer value contained in the updated index position, provided that when the updated index position exceeds the highest possible index position the index position is reset to 0 plus the number of times the highest possible index position has been exceeded, provided that when the number of times the highest possible index position has been exceeded exceeds the highest possible index position the index position is reset to 0.

8. A method as defined in claim 1, wherein the XOR process is modified so that it is not commutative.

9. A method as defined in claim 1, further including the step of storing the ciphertext file together with the first key so as to yield an encrypted file.

10. A method as defined in claim 9, wherein the encrypted file is stored in a manner so as to have a unique suffix appended to the name of the encrypted file and thereby identify the encrypted file as being of a unique file type.

11. A method as defined in claim 10, further including the steps of sending to a decrypting party the encrypted file of the unique file type and providing the decrypting party with software capable of decrypting the encrypted file, so as to yield at least a portion of the plaintext file, and outputting data corresponding to information contained within the plaintext file.

12. A method as defined in claim 11, wherein the software limits or prevents copying, alteration or sending of the information contained within the plaintext file by the decrypting party.

13. A method as defined in claim 1, further including the steps of:
(j) providing to a decrypting party the ciphertext file including blocks of encrypted binary data to be decrypted, the first key, and the second key;
(k) selecting from the ciphertext file a block of encrypted binary data to be decrypted;
(l) selecting, according to the key algorithm, the integer value previously selected from the second key when encrypting the block of encrypted binary data in steps (e)-(h);
(m) inputting, according to the key algorithm, the integer value selected from the second key into the first key so as to obtain the one or more integer values previously selected from the first key when encrypting the block of encrypted binary data in steps (e)-(h);
(n) performing an XOR process on the block of encrypted binary data using the one or more integer values obtained from the first key so as to restore the block of original binary data from which the block of encrypted binary data was generated; and
(o) repeating steps (k)-(n) until at least a portion of the ciphertext file has been decrypted so as to restore at least a portion of the plaintext file.

14. A method as defined in claim 13, wherein the ciphertext and first key are provided to the decrypting party by means of a transmission by an encrypting party over the Internet.

15. A method as defined in claim 15, wherein the ciphertext and first key are provided to the decrypting party by means of HTTPS.

16. A method as defined in claim 13, wherein the second key and key algorithm are provided to the decrypting party as part of a computer-readable medium.

17. A method as defined in claim 13, wherein the second key is provided to the decrypting party by means of a password protected login procedure over a secure line between the decrypting party and an encrypting party.

18. A method as defined in claim 1, wherein the plaintext file is at least one of a graphic file or a text file.

19. A method as defined in claim 1, wherein the plaintext file digitally represents graphic information contained in a tangible document and is a TIFF file.

20. A method as defined in claim 1, wherein the plaintext file digitally represents graphic information contained in a tangible document and is at least one of a JPEG, BMP or GIF file.

21. A method as defined in claim 1, wherein at least one of the first and second keys is unique to the plaintext file.

22. A computerized system comprising means for implementing the method recited in at least one of claims 1 or 12.

23. A computer-readable medium having computer-executable instructions for performing the steps of:
(a) providing a plaintext file that includes blocks of original binary data to be encrypted, said blocks having a given length and a maximum possible integer value;
(b) providing a first key that includes a number of indexed integer values selected from a set bounded below by 0 or 1 and above by the maximum possible integer value of the blocks of binary data to be encrypted;
(c) providing a second key that includes a number of indexed integer values selected from a set bounded below by 0 and above by the predetermined number of indexed integer values included in the first key;
(d) providing a key algorithm that relates the first and second keys together;
(e) selecting from the plaintext file a block of binary data to be encrypted;
(f) selecting, according to the key algorithm, an integer value from the second key;
(g) inputting, according to the key algorithm, the integer value selected from the second key into the first key so as to obtain one or more integer values;
(h) performing an XOR process on the block of original binary data using the one or more integer values obtained from the first key so as to generate a block of encrypted binary data; and
(i) repeating steps (e)-(h) until a desired portion the plaintext file has been encrypted so as to yield a ciphertext file including blocks of encrypted binary data.

24. A computer-readable medium, at least partially separate from the computer readable medium of claim 23, having computer-executable instructions for performing the steps of:
(j) providing to a decrypting party the ciphertext file, generated using the computer-readable medium of claim 23, including blocks of encrypted binary data to be decrypted, the first key, and the second key;
(k) selecting from the ciphertext file a block of encrypted binary data to be decrypted;
(l) selecting, according to the key algorithm, the integer value previously selected from the second key when encrypting the block of encrypted binary data in steps (e)-(h);
(m) inputting, according to the key algorithm, the integer value selected from the second key into the first key so as to obtain the one or more integer values previously selected from the first key when encrypting the block of encrypted binary data in steps (e)-(h);
(n) performing an XOR process on the block of encrypted binary data using the one or more integer values obtained from the first key so as to restore the block of original binary data from which the block of encrypted binary data was generated; and
(o) repeating steps (k)-(n) until at least a portion of the ciphertext file has been decrypted so as to restore at least a portion of the plaintext file.

25. A computer-readable medium as defined in claim 23, wherein at least one of the first and second keys is unique to the plaintext file.

26. A method for protecting an electronic file sent over the Internet from unauthorized access, copying or alteration, comprising:
(a) encrypting a plaintext file using an encryption algorithm, a public key, and a private key so as to generate a ciphertext file;
(b) storing the ciphertext file together with the public key so as to yield a composite file of a unique file type;
(c) sending the composite file to an authorized decrypting party over the Internet;
(d) separately providing the decrypting party with the private key and a decryption algorithm corresponding to the encryption algorithm which, together with the public key provided as part of the composite file, allow the decrypting party to at least partially decrypt the ciphertext file and restore at least a portion of the plaintext file.

27. A method as defined in claim 26, wherein the private key and decryption algorithm are integrated together as part of a restricted output algorithm which inhibits or prevents copying, alteration and sending of the restored portion of the plaintext file.

28. A method as defined in claim 27, wherein the plaintext file digitally represents information contained in a tangible document and wherein the restricted output algorithm includes an algorithm for outputting at least a portion of the information contained in the tangible document.

29. A method as defined in claim 28, wherein the plaintext file is at least one of a graphic file or a text file.

30. A method as defined in claim 28, wherein the plaintext file is a TIFF file.

31. A method as defined in claim 26, wherein at least one of the first and second keys is unique to the plaintext file.

32. A computerized system comprising means for implementing the method recited in claim 26.

33. A method for decrypting an encrypted file while preventing or inhibiting copying, alteration or sending of decrypted plaintext data, comprising:
(a) providing a decrypting party with a ciphertext file, a decryption algorithm and key necessary to decrypt the ciphertext file so as to restore at least a portion of a plaintext file corresponding to the ciphertext file, and an output algorithm integrated with the decryption algorithm and key that permits at least one of viewing or printing of information relating to the plaintext file but which prevents or inhibits copying, alteration or transmission of said information;
(b) permitting the decrypting party to decrypt the ciphertext file using the decryption algorithm and key so as to restore at least a portion of the plaintext file corresponding to the ciphertext file, wherein the output algorithm permits at least one of viewing or printing of the information relating to the plaintext file but which prevents or inhibits copying, alteration or transmission of said information.

34. A method as defined in claim 33, wherein the decryption algorithm and output algorithm are provided to the decrypting party in the form of a computer-readable medium.

35. A method as defined in claim 33, wherein the ciphertext and a first portion of the key are provided to the decrypting party by means of a transmission from an encrypting party over the Internet and wherein a second portion of the key is separately provided to the decrypting party in a manner so that only the encrypting and decrypting parties have access to the private key.

36. A method as defined in claim 35, wherein the second portion of the key is provided to the decrypting party together with the decryption algorithm.

37. A method as defined in claim 35, wherein the second portion of the key is provided to the decrypting party by means of a password-protected login procedure.

38. A method as defined in claim 35, wherein at least one of the first and second portions of the key is unique to the plaintext file.

39. A computerized system comprising means for implementing the method recited in claim 33.
